(19) United States
(12) Patent Application Publication
(10) Pub. No.: US 2026/0277566 A1
(43) Pub. Date: Sep. 17, 2026

(54) METHODS AND SYSTEMS FOR AUTOMATED CODE GENERATION

(71) Applicant: Versa Networks, Inc., Santa Clara, CA (US)

(72) Inventors: Julie Huynh, Hayward, CA (US); Zhonghua Joshua Xu, Richmond Hill (CA); Satwinder Singh, Toronto (CA); Victor Wu, Waterloo (CA)

(21) Appl. No.: 19/076,909

(22) Filed: Mar. 11, 2025

(51) Int. Cl. G06F 8/38; G06F 8/71

(52) U.S. Cl. CPC G06F 8/38; G06F 8/71

(57) ABSTRACT

Systems, methods, and computer program products are provided for automatically generating JSX code. The method includes receiving a selection of a user interface component and extracting metadata associated with the selected component. The extracted metadata is analysed to identify a plurality of user interface component properties. Based on the metadata analysis, a string representation of the user interface component is generated in a JSX format by mapping the identified properties to corresponding JSX elements. The method further modifies the string representation based on user-defined criteria to generate JSX code. The modification includes filtering the string representation to selectively include or exclude specific properties, managing a nesting properties configuration to maintain structural integrity, and refining the string representation by evaluating context-aware dependencies and applying conditional functions. The disclosed method enhances efficiency in JSX code generation, reducing manual effort while ensuring accuracy and consistency in UI component representation.

### BACKGROUND

Modern software development workflows rely on efficient design-to-development handoff processes to ensure that user interface (UI) components are implemented accurately and consistently. Design tools, such as Figma, allow designers to create detailed UI components that are then visualized in environments like Storybook for review and collaboration. However, the transition from design to functional code frequently involves a manual translation process wherein developers must interpret design specifications, identify necessary APIs and properties, and code the corresponding JSX components for React-based applications. This manual process is prone to errors, inconsistencies, and inefficiencies, as it requires developers to repeatedly determine the correct implementation details and may lead to misinterpretations of the original design intent.

Traditional workflows for converting design specifications into JSX code often provide only rudimentary code export functionalities. These exports typically lack the dynamic behavior, state management, and framework-specific optimizations required for production-quality code. Consequently, developers are compelled to manually refine and adjust the generated code, which increases development time and introduces the potential for errors. Moreover, the limited automation in existing tools restricts the ability of non-technical stakeholders, such as designers and product managers, to contribute directly to the code generation process, thereby creating bottlenecks in the development cycle and hampering overall productivity.

### SUMMARY

In accordance with an embodiment of the invention, a method for automatically generating a JSX code is generated. The method includes receiving a selection of a user interface component, extracting metadata associated with the user component, and analyzing the metadata to identify a plurality of user interface component properties. The method further includes generating a string representation of the user components in a JSX format based on the metadata analysis by mapping the plurality of user interface component properties to corresponding JSX elements, and modifying the string representation. Modification of the string representation, which is based on an user-defined criteria to generate the JSX code for the each user component, includes filtering the string representation to selectively include or exclude at least one of the plurality of user interface component properties from the string representation, managing a nesting properties configuration corresponding to the user interface component, and refining the string representation by evaluating context-aware dependencies and applying conditional function to the string representation.

In some embodiments, the design tool comprises a graphical user interface design platform configured to export structured metadata for the user component.

In some embodiments, the string representation is dynamically adjusted based on framework-specific constraints, including compatibility with React-based component libraries.

In some embodiments, automatically generating an equivalent HTML layout of the modified string representation.

In some embodiments, the JSX code is generated based on a plurality of string representations, and wherein each representation corresponds to a respective user interface component.

In some embodiments, the JSX code is generated as a snippet enabled with a copy-paste functionality.

In some embodiments, the nesting properties configuration is managed based on a hierarchical order of nested dependencies associated with each user interface component.

In some embodiments, the JSX code is stored, and wherein the stored JSX code is version-controlled and allows for tracking modifications and rollback of changes.

In some embodiments, the string representation generation is further based on the Application Programming Interface applicable for usage of the user component.

In another embodiment, a non-transitory computer readable storage medium containing program instructions is disclosed. The non-transitory computer readable storage medium, when executed by a computer cause the computer to perform operations including receiving a selection of a user interface component, extracting metadata associated with the user component, and analyzing the metadata to identify a plurality of user interface component properties. The operations further include generating a string representation of the user components in a JSX format based on the metadata analysis by mapping the plurality of user interface component properties to corresponding JSX elements and modifying the string representation, based on a user-defined criteria, to generate the JSX code for the each user component. Modifying the string representation includes filtering the string representation, to selectively include or exclude at least one of the plurality of user interface component properties from the string representation, managing a nesting properties configuration corresponding to the user interface component, and refining the string representation by evaluating context-aware dependencies and applying conditional function to the string representation.

In yet another embodiment, a system for automatically generating a JSX code is disclosed. The system includes one or more processors and a memory coupled to the one or more processors. The memory stores instructions, which, when executed by the one or more processors, cause the system to receive a selection of a user interface component, extract metadata associated with the user component, and analyse the metadata to identify a plurality of user interface component properties. The system generates a string representation of the user components in a JSX format based on the metadata analysis by mapping the plurality of user interface component properties to corresponding JSX elements. The system then modifies the string representation, based on an user-defined criteria, to generate the JSX code for the each user component. Modifying the string representation includes filtering the string representation, to selectively include or exclude at least one of the plurality of user interface component properties from the string representation, managing a nesting properties configuration corresponding to the user interface component, and refining the string representation by evaluating context-aware dependencies and applying conditional function to the string representation.

Other aspects and advantages of embodiments of the present invention will become apparent from the following detailed description taken in conjunction with the accompanying drawings.

### BRIEF DESCRIPTION OF THE DRAWINGS

FIG. 1 is a block diagram illustrating a conventional method for translating user interface (UI) components into Javascript XML (JSX) code, in accordance with certain embodiments

FIG. 2 is a high-level block diagram of a system environment, in accordance with certain embodiments.

FIG. 3 is a block diagram of a system for automatically generating JSX code, in accordance with certain embodiments.

FIG. 4 is a graphical user interface (GUI) screen image illustrating an interface for Storybook integration, in accordance with certain embodiments

FIG. 5 is a graphical user interface (GUI) screen image illustrating an interface for JSX code generation. in accordance with certain embodiments

FIG. 6 is a flow diagram illustrating a method for automatically generating JSX code, in accordance with certain embodiments

FIG. 7 shows an example computer system that can be used to implement the malware detection system, according to certain embodiments in accordance with certain embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

### Introduction

Embodiments of the present disclosure provide an automated approach for generating JSX code from user interface components. Conventional methods for implementing UI components require developers to manually analyze design specifications, extract necessary properties, and convert them into JSX code. This manual process introduces inconsistencies, increases development time, and can lead to misinterpretation of component attributes. Additionally, existing solutions lack an efficient mechanism for dynamically filtering and modifying component properties before JSX generation.

In accordance with the present disclosure, metadata associated with a selected user interface component is extracted and analyzed to identify relevant properties. The extracted metadata is then mapped to JSX elements, generating a structured string representation of the component. The generated JSX code undergoes refinement through user-defined criteria, enabling selective inclusion or exclusion of properties, managing nesting configurations, and applying contextual dependencies for optimized JSX generation.

The present disclosure, thus, addresses the inefficiencies in JSX code generation by reducing manual intervention, ensuring structural consistency, and providing dynamic customization of UI components. By integrating metadata extraction, automated JSX mapping, and real-time refinement techniques, the invention enhances accuracy and efficiency in UI development, minimizing the complexity traditionally associated with JSX code implementation.

### Prior Art

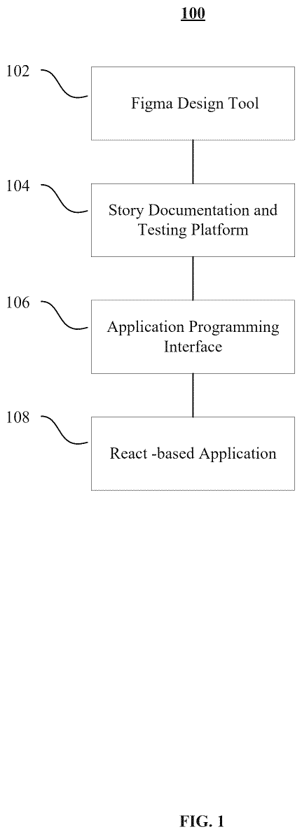

FIG. 1 is a block diagram illustrating a conventional method for translating user interface (UI) components into Javascript XML (JSX) code. The system environment 100 comprises a design tool 102, a Storybook documentation and testing platform 104, an Application Programming Interface (API) 106, and a React-based application 108. As shown in FIG. 1, the design tool 102 is a Figma design tool 102 that allows designers to create and document UI components, which are then passed to the Storybook documentation and testing platform 104 for further validation.

The API 106 serves as an intermediary between the Storybook documentation and testing platform 104 and the React-based application 108. In conventional workflows, developers must manually extract component properties and APIs from the API 106, process the extracted data, and then implement the UI components within the React-based application 108. The API-based approach introduces potential inefficiencies, as developers are required to interpret API responses, determine required props, and manually translate design elements into JSX code.

The system environment 100 presents the primary challenge associated with the conventional method which is manual intervention in JSX code generation. Because the API 106 requires developers to analyze and transform the received data, inconsistencies, misinterpretations, and increased development time may result. Additionally, non-developers, such as designers and product managers, lack direct access to JSX code generation, further limiting efficiency in the design-to-development handoff process.

### System Environment

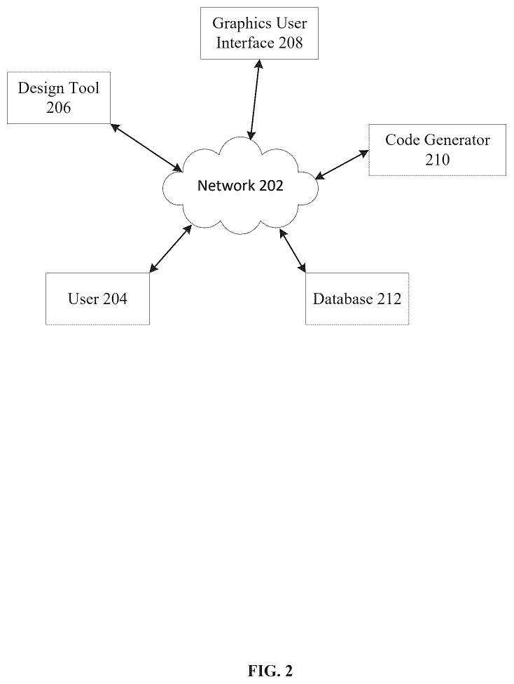

FIG. 2 is a block diagram of a system environment 200, in accordance with an embodiment. The system environment 200 includes one or more users 204, a design tool 206, a graphical user interface 208, a code generator 210, and a database 212 interconnected through a network 202.

The network 202 facilitates communication between the user 204 and the system components, enabling seamless transmission of UI design data. The network 202 may comprise any wired or wireless communication infrastructure, such as the Internet, a corporate wide area network (WAN), a cloud-based virtual network, or an intranet. The network 202 may support various communication protocols, including HTTP, HTTPS, TCP/IP, WebSocket, or RESTful API interactions. The network 202 may also include network nodes that handle data transmission, processing, and security protocols, ensuring efficient communication between the system components.

The one or more users 204, combinedly referred to as user 204, may be a developer, designer, product manager, or any stakeholder involved in the UI component development process. The user interacts with the design tool 206 to create UI components and may refine or customize the generated JSX code using the graphical user interface 208. In some embodiments, the design tool 206 may support multiple users collaborating in real time, with role-based access controls to manage permissions and editing capabilities.

The design tool 206 is an integrated platform for the creation, documentation, and management of user interface (UI) components, providing a comprehensive graphical user interface that enables designers and developers to construct and refine components in isolation from the primary application framework. Examples of such design tools include Figma, Adobe XD, and Sketch. The design tool 206 may export design components in structured formats, such as JSON, SVG, or proprietary metadata formats, which are then processed by the code generator 210. The design tool 206 incorporates a modular workspace for the hierarchical organization of components, supports automatic generation and real-time updating of structured metadata, such as including detailed properties, styling parameters, layout configurations, and conditional attributes, and offers interactive control interfaces with live preview capabilities for iterative design validation.

The graphical user interface 208 provides an interactive interface that allows users to modify component properties, apply filtering mechanisms, and customize the JSX output. The graphical user interface 208 may be implemented as a web-based dashboard, a desktop application, or an integrated development environment plugin. The graphical user interface 208 may include drag-and-drop functionality, pre-defined templates, and syntax validation features to assist users in generating JSX code efficiently.

The code generator 210 processes metadata extracted from UI components and automatically generates JSX representations based on predefined rules and framework-specific constraints. The code generator 210 may include various processing modules, such as a dynamic property filtering module that determines which properties should be included in the JSX output based on predefined heuristics or user input, a context-aware property management module that ensures that the generated JSX code is compatible with different states and conditions of UI components, an AI-based optimization module that utilizes machine learning algorithms to optimize component structures and remove redundant properties, and a framework-specific formatter that adjusts JSX output for compatibility with React, Next.js, or other JavaScript frameworks.

The database 212 serves as a storage repository for UI components, metadata, and generated JSX code. The database may be implemented using SQL-based relational databases such as PostgreSQL or MySQL, NoSQL document stores such as MongoDB or Firebase, or cloud-based storage solutions such as AWS S3 or Google Cloud Storage. The database 212 may support version control mechanisms to track changes in UI components and JSX representations, allowing users to revert to previous versions when necessary.

In one embodiment, the system environment 200 supports multiple workflows for JSX code generation. For example, a designer using the design tool 206 creates a UI component, which is then analyzed by the code generator 210 to generate a structured JSX representation. The user 204 can further refine the generated JSX code using filtering options provided via the graphical user interface 208. The final JSX output is stored in the database 212 for retrieval and reuse.

In alternative embodiments, the system environment 200 may incorporate additional components, such as API integration modules, AI-based optimization engines, and extended support for multiple front-end frameworks. The additional components may further streamline the JSX generation process by reducing developer workload, minimizing errors, and accelerating the design-to-development workflow.

### System for Code Generation

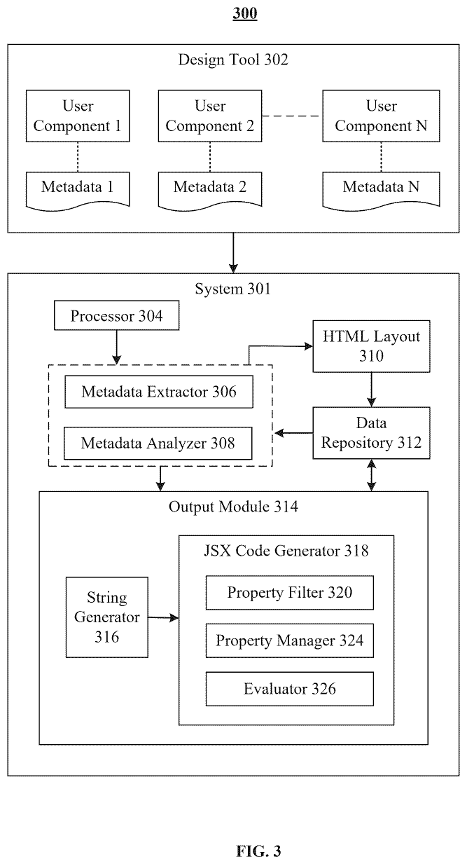

FIG. 3 is a block diagram of a system 300 for automatically generating JSX code, in accordance with an embodiment. The system 300 comprises a design tool 302, and a system 301. The system 301 includes a processor 304 having a metadata extractor 306 and a metadata analyser 308, a data repository 312, an HTML layout generator 310, and an output module 314. The output module 314 comprises a string generator 316 and a JSX code generator 318 having a property filter 320, a property manager 324, and an evaluator 326.

In one aspect, the design tool 302 is a representation of the design tool 202 as described through FIG. 2. The design tool 302 provides a graphical user interface through which users create and document UI components. The system 301 interacts with the design tool 302 to receive user selection of one or more UI components and corresponding JSX code generation. In the illustrated embodiment, the design tool 302 is implemented as a Storybook environment, which serves as an integrated graphical user interface for the creation, documentation, and storage of UI components. The Storybook environment is configured to provide a comprehensive platform wherein developers and designers may collaboratively develop modular UI components in isolation from the primary application framework.

Within the Storybook environment, individual UI components are created by defining their visual presentation and interactive behavior. For example, a “Primary Button” component may be developed with specific visual attributes, such as color, typography, margin, and padding, as well as functional properties including a label indicating a type string, an event handler indicating a type function, and a disabled state indicating a type boolean. The properties associated with each component are embedded as structured metadata, which includes, but is not limited to, property names, data types, default values, and permissible value ranges. In addition, the metadata may comprise nested attributes and conditional dependencies that dictate the dynamic behavior of the components.

The system 301 is configured to receive metadata from the design tool 302. The system 301 comprises the processor 304 which is a central processing unit configured to execute program instructions for processing UI component metadata and generating JSX code. The processor 304 is operable to perform complex computational tasks, including the orchestration of metadata extraction, analysis, and JSX code generation. In embodiments, the processor 304 may be implemented as a multi-core processor or a combination of central and graphical processing units, thereby enabling parallel processing of multiple UI component metadata streams. The processor 304 executes instructions stored in a non-transitory computer-readable medium and is responsible for managing system resources, scheduling tasks, and ensuring the efficient execution of real-time updates and dynamic refinements to the generated JSX code.

For processing the metadata, the metadata extractor 306 retrieves structured metadata from the UI components designed in the design tool 302. The metadata may include component properties, styles, and structural attributes that are used for JSX code generation. The extracted metadata is stored in the data repository 312 for further analysis and processing.

The metadata extractor 306 is configured to extract metadata associated with the one or more UI components selected by the user through the design tool 302. The metadata extractor 306 accesses design files or exported artifacts, such as JSON, XML, or proprietary file formats that contains comprehensive metadata for each UI component. The metadata includes, but is not limited to, component properties (e.g., property names, data types, default values, and permissible ranges), styling information, and structural attributes. In addition, the metadata extractor 306 is designed to identify and extract nested attributes and conditional dependencies, thereby the entire design specification is captured with high fidelity. The metadata extractor 306 may utilize parsing algorithms and heuristics to resolve ambiguities inherent in the exported design data and to standardize the metadata for subsequent analysis.

The metadata analyser 308 is configured to analyse the metadata to identify a plurality of user interface component properties. In one aspect, the metadata analyser 308 processes the structured metadata extracted by the metadata extractor 306 to determine the relevant UI component properties and the corresponding relationships. The metadata analyser 308 maps the extracted metadata attributes to corresponding JSX elements, identifying hierarchical nesting relationships and evaluating conditional dependencies that govern component behavior. The nesting properties configuration is managed based on a hierarchical order of nested dependencies associated with the each user interface component.

In embodiments, the metadata analyser 308 implements context-aware evaluation and dynamic property filtering to refine the metadata prior to code generation. The analysis is performed so that the generated JSX code accurately reflects the intended design, including the proper handling of nested components and the inclusion or exclusion of specific properties based on user-defined criteria.

Based on the analysis, a code corresponding to the selected UI components may be generated in a format other than the JSX format. In one implementation, the code is generated as a Hypertext Markup Language (HTML) layout. The HTML layout generator 310 of the system 301 creates an intermediate HTML representation of the UI components. The HTML layout generator 310 ensures that all UI elements maintain their original structure and layout hierarchy. In another aspect, the code may be generated in other formats, such as JSON. The system 301 may include additional components for generating the code in different formats.

The generated code is stored in the data repository 312. The data repository 312, in one aspect, stores extracted metadata, intermediate HTML layouts, and generated JSX code for future reference and reuse. The repository supports version control, enabling users to track modifications, revert to previous states, and maintains consistency across iterations. The data repository 312 may be implemented using cloud-based storage, relational databases, or NoSQL systems, allowing scalable access to stored component data across multiple development environments. Additionally, the data repository 312 renders accessibility for collaborative teams working across different time zones or locations.

The metadata analysed by the metadata analyser 308 is then processed by the output module 314 for automatic JSX code generation corresponding to the selected UI components. The output module 314 includes a string generator 316 for string generation and a JSX code generator 318 for JSX code generation.

The string generator 316 constructs a string representation of the UI components in a JSX format by mapping the analyzed metadata attributes to JSX elements. The JSX code generator 318 converts the string representation into JSX code optimized for integration with React-based development environments. The generated JSX code includes all required component properties, ensuring accurate implementation of the designed UI components.

The generated string is then processed by the JSX code generator 318 that allows the user to modify and refine the string and generate a final JSX code output. The JSX code is generated based on a plurality of string representations, and each representation corresponds to a respective user interface component. If a single UI component is selected, the JSX code is generated based on the string representation of the single UI component.

The JSX code generator 318 includes the property filter 320, the property manager 324, and the evaluator 326.

The property filter 320 allows users to selectively include or exclude specific UI component properties from the JSX output. The property filter 320 applies predefined rules and user-defined criteria to refine the JSX representation. User-defined criteria may include selecting specific component attributes such as colors, typography settings, padding, margin properties, or conditional rendering logic. For example, a user may choose to exclude accessibility-related attributes if the JSX component is being generated for an internal tool. Similarly, developers may configure the filter to remove default values for properties such as width and height when these properties are dynamically determined at runtime.

The property manager 324 is configured such that the JSX output maintains proper nesting configurations and hierarchical consistency. The property manager 324 dynamically adjusts nested component properties based on contextual dependencies, optimizing the JSX code for seamless integration. The property manager also allows users to define nesting rules that dictate how sub-components are structured within the parent component. For instance, a user can specify that a button component must always be encapsulated within a form container, ensuring logical structure enforcement in the JSX output. The property manager 324 further validates that nested elements follow the correct UI framework conventions, reducing errors related to improper component hierarchy.

The evaluator 326 applies conditional logic to further refine the JSX output. The evaluator 326 assesses contextual dependencies, applying conditional functions to determine the inclusion or exclusion of properties in the JSX representation. With application of the conditional logic and maintaining the contextual dependencies, only relevant properties are retained in the JSX code, improving clarity and maintainability. The final JSX output is stored in the data repository 312 for version control and reuse.

The system 300 may be implemented as a cloud-based service, an integrated development environment (IDE) plugin, or a standalone application. In one embodiment, a user selects a UI component from the design tool 302, and the system 301 automatically generates JSX code for that component. The JSX code may be presented as a snippet with one-click functionality of copy and paste. The generated JSX code is displayed through the output module 314, allowing users to copy and paste the JSX snippet directly into a development environment. The system 300 supports real-time updates, enabling users to refine component properties and regenerate JSX code dynamically.

In alternative embodiments, the system 300 may incorporate additional optimization modules, such as AI-based analysis engines and framework-specific JSX formatters. The AI-based analysis engine may enhance JSX generation by learning from user interactions and predicting optimal component structures. The framework-specific JSX formatters adjust the generated JSX output to align with the syntax and conventions of different front-end frameworks. The system 300 thus renders an efficient design-to-development workflow, reducing manual coding effort and minimizing errors in UI component implementation.

### Storybook Integration

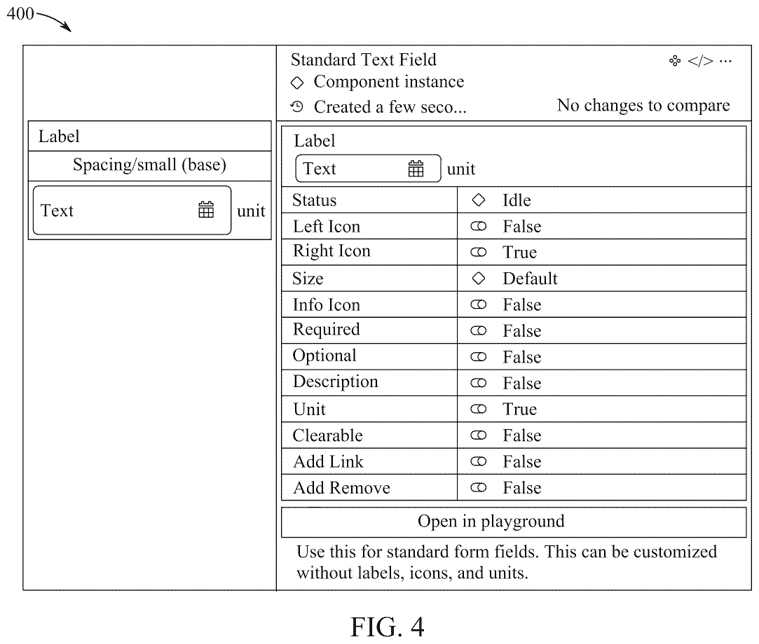

FIG. 4 is a graphical user interface (GUI) screen image illustrating an interface for Storybook integration, in accordance with an embodiment. The GUI screen image displays a UI component that has been designed in Figma and replicated in Storybook. The interface allows users to view, interact with, and modify the component while maintaining consistency between the design tool and the implementation environment. The UI component presented in the GUI represents a standard text field, providing an example of how Storybook integration maintains component fidelity across platforms.

The GUI screen image includes a section displaying the component instance, labeled as a “Standard Text Field.” The instance provides various configuration options, such as label spacing, left and right icons, size adjustments, required or optional fields, and additional attributes such as status, description, unit input, and clearable options. Users can compare different versions of the component and apply modifications directly through the interface. The interface further includes a playground feature, which allows users to preview and test different component settings before final implementation. With configuration of the GUI, each modification is reflected in real time within Storybook, enabling a streamlined workflow for both designers and developers.

### Code Generation Interface

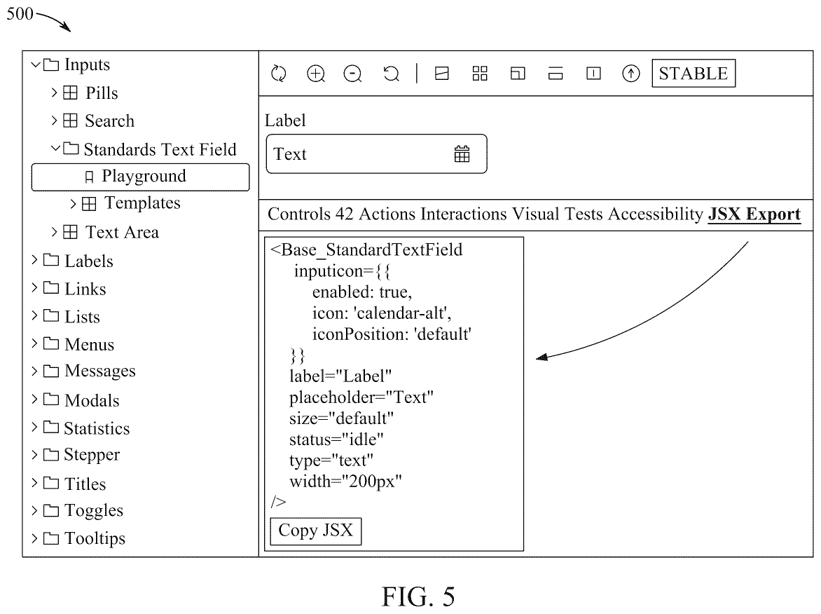

FIG. 5 is a graphical user interface (GUI) screen image illustrating an interface for JSX code generation, in accordance with an embodiment. The GUI screen image provides a user interface that allows users to customize the string representation of a UI component and generate the final JSX code output. The system enables real-time modification of component properties, ensuring that the generated JSX code accurately reflects user-defined configurations.

The GUI screen image includes a structured JSX representation of a text field component. The JSX export tab enables users to view, copy, and paste the JSX code directly into their development environment. The JSX code representation includes key properties such as input icon configurations, label text, placeholder values, component size, status, type, and width. The generated JSX code thus retains all necessary parameters for proper integration into a React-based environment. Users can enable or disable icons, adjust the placeholder text, and set the width of the text field dynamically through the configuration panel.

The interface further includes various controls, allowing users to interact with the component's actions, test visual representations, and validate accessibility parameters. The controls panel provides developers with interactive features such as modifying the component's state, testing different scenarios, and verifying compliance with accessibility standards. The ability to manipulate JSX properties dynamically through an interactive interface reduces manual coding effort and ensures that components are correctly structured for deployment. With implementation of the system the user can generate, modify, and export JSX code seamlessly while maintaining strict adherence to design specifications.

### Method for Automated JSX Code Generation

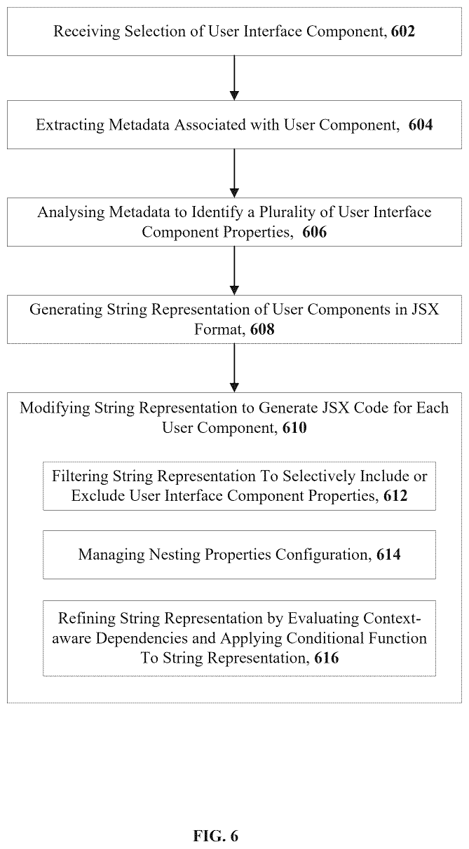

FIG. 6 is a flow diagram illustrating a method for automatically generating JSX code, in accordance with an embodiment. The method includes multiple stages that collectively render accurate extraction, transformation, and refinement of JSX code for user interface components.

At step 602, the method 600 includes receiving a selection of a user interface component. A user may select a UI component from a graphical user interface design platform or a development environment. The selected UI component may include a plurality of attributes, such as labels, input fields, buttons, and other interactive elements. The system detects the selection and initiates the metadata extraction process.

Upon selection of the UI component, the metadata associated with the selected UI component is extracted, at step 604. The metadata includes structural properties, style attributes, interactions, and layout configurations. Metadata is extracted for each selected UI component.

At step 606, the system analyzes the extracted metadata to identify a plurality of user interface component properties. The analysis phase involves mapping the metadata attributes to JSX-compatible elements, ensuring that each component property is appropriately recognized. This includes identifying required properties, default values, and optional attributes that influence the UI component's behavior.

At step 608, the system generates a string representation of the user components in JSX format. The generated string representation serves as a structured template that encapsulates all component properties and attributes in a JSX-compatible syntax.

At step 610, the system modifies the string representation to generate JSX code for each user component based on user-defined criteria. This modification process allows for customization of the JSX output according to project-specific requirements. The modification phase includes additional refinements such as dynamic property assignment and syntax adjustments to optimize the JSX structure.

At step 612, the system applies a filtering mechanism to selectively include or exclude specific user interface component properties. The filtering process is implemented such that the unnecessary properties are removed, and only essential attributes are retained. Users may define filtering rules to streamline the JSX code and enhance its readability.

At step 614, the system manages the nesting properties configuration corresponding to the user interface component. Nesting configuration ensures that hierarchical relationships between components are preserved, maintaining structural integrity. The nesting configuration allows the JSX output to reflect parent-child relationships accurately, enabling seamless integration into complex UI layouts.

At step 616, the system refines the string representation by evaluating context-aware dependencies and applying conditional functions. Refinement generates the final JSX output that accounts for dependencies between components, dynamically adjusting property assignments based on contextual relationships. The application of conditional logic further optimizes the JSX code by removing redundant attributes and refining the component behavior.

### Computer Architecture

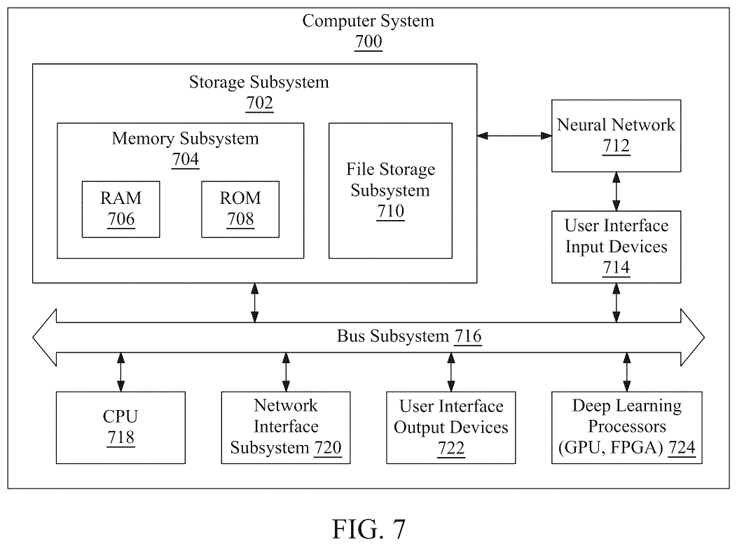

FIG. 7 shows an example computer system 700 that can be used to implement the technology disclosed. The computer system 700 is a representation of the malware detection system 200, as described in FIG. 2A. The computer system 700 includes at least one central processing unit (CPU) 718 that communicates with a number of peripheral devices via bus subsystem 716. These peripheral devices can include a storage subsystem 702 including, for example, memory devices and a file storage subsystem 710, user interface input devices 714, user interface output devices 722, and a network interface subsystem 720. The input and output devices allow user interaction with computer system 700. Network interface subsystem 720 provides an interface to outside networks, including an interface to corresponding interface devices in other computer systems.

In one implementation, a neural network 712 is communicably linked to the storage subsystem 702 and the user interface input devices 714.

User interface input devices 714 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 700.

User interface output devices 722 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 700 to the user or to another machine or computer system.

Storage subsystem 702 stores programming and data constructs that provide the functionality of some or all of the modules and methods described herein. These software modules are generally executed by deep learning processors 724.

Deep learning processors 724 can be graphics processing units (GPUs), field-programmable gate arrays (FPGAs), application-specific integrated circuits (ASICs), and/or coarse-grained reconfigurable architectures (CGRAs). Processors 724 can be hosted by a deep learning cloud platform such as Google Cloud Platform™, Xilinx™, and Cirrascale™. Examples of processors 724 include Google's Tensor Processing Unit (TPU)™, rackmount solutions like GX4 Rackmount Series™, GX6 Rackmount Series™, NVIDIA DGX-1™, Microsoft's Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 704 used in the storage subsystem 702 can include a number of memories including a main random-access memory (RAM) 706 for storage of instructions and data during program execution and a read only memory (ROM) 708 in which fixed instructions are stored. A file storage subsystem 710 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 710 in the storage subsystem 702, or in other machines accessible by the processor.

Bus subsystem 716 provides a mechanism for letting the various components and subsystems of computer system 700 communicate with each other as intended. Although bus subsystem 716 is shown schematically as a single bus, alternative implementations of the bus subsystem can use multiple buses.

Computer system 700 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 700 depicted in FIG. 7 is intended only as a specific example for the purpose of illustrating the preferred implementations of the present technology disclosed. Many other configurations of computer system 700 are possible having more or fewer components than the computer system depicted in FIG. 7.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a non-transitory computer-readable storage medium for execution by a computer. As an example, an embodiment of a non-transitory computer-readable storage medium includes a computer useable storage medium configured to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for automatically generating a JSX code, the method comprising:
receiving a selection of a user interface component;
extracting metadata associated with the user component;
analysing the metadata to identify a plurality of user interface component properties;
generating a string representation of the user components in a JSX format based on the metadata analysis by mapping the plurality of user interface component properties to corresponding JSX elements; and
modifying the string representation, based on an user-defined criteria, to generate the JSX code for the each user component, comprising:
filtering the string representation to selectively include or exclude at least one of the plurality of user interface component properties from the string representation,
managing a nesting properties configuration corresponding to the user interface component, and
refining the string representation by evaluating context-aware dependencies and applying conditional function to the string representation.

2. The method of claim 1, wherein the design tool comprises a graphical user interface design platform configured to export structured metadata for the user component.

3. The method of claim 1, wherein the string representation is dynamically adjusted based on framework-specific constraints, including compatibility with React-based component libraries.

4. The method of claim 1, further comprising automatically generating an equivalent HTML layout of the modified string representation.

5. The method of claim 1, wherein the JSX code is generated based on a plurality of string representations, and wherein each representation corresponds to a respective user interface component.

6. The method of claim 1, wherein the JSX code is generated as a snippet enabled with a copy-paste functionality.

7. The method of claim 1, wherein the nesting properties configuration is managed based on a hierarchical order of nested dependencies associated with the each user interface component.

8. The method of claim 1, wherein the JSX code is stored, and wherein the stored JSX code is version-controlled and allows for tracking modifications and rollback of changes.

9. The method of claim 1, wherein the string representation generation is further based on the Application Programming Interface applicable for usage of the user component.

10. A non-transitory computer readable storage medium containing program instructions, which when executed by a computer cause the computer to perform operations comprising:
receiving a selection of a user interface component;
extracting metadata associated with the user component;
analysing the metadata to identify a plurality of user interface component properties;
generating a string representation of the user components in a JSX format based on the metadata analysis by mapping the plurality of user interface component properties to corresponding JSX elements; and
modifying the string representation, based on an user-defined criteria, to generate the JSX code for the each user component, comprising:
filtering the string representation, to selectively include or exclude at least one of the plurality of user interface component properties from the string representation,
managing a nesting properties configuration corresponding to the user interface component, and
refining the string representation by evaluating context-aware dependencies and applying conditional function to the string representation.

11. The non-transitory computer readable storage medium of claim 10, wherein the string representation is dynamically adjusted based on framework-specific constraints, including compatibility with React-based component libraries.

12. The non-transitory computer readable storage medium of claim 10, further comprising automatically generating an equivalent HTML layout of the modified string representation.

13. The non-transitory computer readable storage medium of claim 10, wherein the JSX code is generated based on a plurality of string representations, and wherein each representation corresponds to a respective user interface component.

14. The non-transitory computer readable storage medium of claim 10, wherein the nesting properties configuration is managed based on a hierarchical order of nested dependencies associated with the each user interface component.

15. A system for automatically generating a JSX code, comprising:
one or more processors; and
a memory coupled to the one or more processors, the memory storing instructions, which, when executed by the one or more processors, cause the system to:
receiving a selection of a user interface component;
extracting metadata associated with the user component;
analysing the metadata to identify a plurality of user interface component properties;
generating a string representation of the user components in a JSX format based on the metadata analysis by mapping the plurality of user interface component properties to corresponding JSX elements; and
modifying the string representation, based on an user-defined criteria, to generate the JSX code for the each user component, comprising:
filtering the string representation, to selectively include or exclude at least one of the plurality of user interface component properties from the string representation,
managing a nesting properties configuration corresponding to the user interface component, and
refining the string representation by evaluating context-aware dependencies and applying conditional function to the string representation.

16. The system of claim 15, wherein the design tool comprises a graphical user interface design platform configured to export structured metadata for the user component.

17. The system of claim 15, wherein the design tool comprises a graphical user interface design platform configured to export structured metadata for the user component.

18. The system of claim 15, wherein the JSX code is generated as a snippet enabled with a copy-paste functionality.

19. The system of claim 15, wherein the JSX code is stored, and wherein the stored JSX code is version-controlled and allows for tracking modifications and rollback of changes.

20. The system of claim 15, wherein the string representation generation is further based on the Application Programming Interface applicable for usage of the user component.
